(19) United States
(12) Patent Application Publication
(10) Pub. No.: US 2026/0251802 A1
(43) Pub. Date: Aug. 27, 2026

(54) METHOD AND SYSTEM FOR MONITORING DEFORMATION OF FIRE-AFFECTED BUILDING BASED ON AIR-GROUND REMOTE SENSING NETWORKING

(71) Applicants: Cathay Safety Technology Co., Ltd., Beijing (CN); China Academy of Safety Science and Technology, Beijing (CN)

(72) Inventors: Hao ZHANG, Beijing (CN); Xiaolin YANG, Beijing (CN); Guiwen REN, Beijing (CN); Shanshan HOU, Beijing (CN); Yu WANG, Beijing (CN); Guohui ZHOU, Beijing (CN)

(21) Appl. No.: 19/297,413

(22) Filed: Aug. 12, 2025

(30) Foreign Application Priority Data
Feb. 27, 2025 (CN) 202510220106.0

(51) Int. Cl. G01S 19/31; B64U 20/80; B64U 101/30; G01J 5/00; G01S 19/02; G06F 17/16

(52) U.S. Cl. CPC G01S 19/31; B64U 20/80; G01S 19/02; G06F 17/16; B64U 2101/30; G01J 2005/0077

(57) ABSTRACT

Provided are a method and a system for monitoring deformation of a fire-affected building based on air-ground remote sensing networking. The method includes: acquiring radar images by a ground-based deformation monitoring radar A, an unmanned aerial vehicle-mounted deformation monitoring radar B, and an unmanned aerial vehicle-mounted deformation monitoring radar C; performing geocoding on a remote sensing image acquired by each radar, mapping two-dimensional image coordinates, in a radar slant range-azimuth polar coordinate system, of a fire-affected building structure target to local three-dimensional spatial coordinates; and iteratively resolving, based on distributed radar network monitoring, a three-dimensional deformation component and a three-dimensional deformation speed of the fire-affected building structure target. Therefore, high-precision monitoring for three-dimensional deformation of the fire-affected building structure target in a fire emergency response scenario can be achieved.

### CROSS REFERENCE TO RELATED APPLICATION

This patent application claims the benefit and priority of Chinese Patent Application No. 202510220106.0, filed with the China National Intellectual Property Administration on Feb. 27, 2025, the disclosure of which is incorporated by reference herein in its entirety as part of the present application.

### TECHNICAL FIELD

The present disclosure belongs to the field of remote sensing monitoring technologies for fire-affected building deformation, and in particular, relates to a method and a system for monitoring deformation of a fire-affected building based on air-ground remote sensing networking.

### BACKGROUND

Fire-affected buildings face a situation characterized by rapid fire spread, great difficulty in personnel evacuation, susceptibility to secondary disasters such as gas leakage and collapses, and a lack of effective safety monitoring means. The collapse of fire-affected buildings is likely to cause severe consequences, including mass casualties, huge economic losses, social panic, and the like. In firefighting and rescue processes, fire-affected building collapses not only pose a significant threat to lives of firefighting and rescue personnel, but also impose severe pressure on on-site decision-making and implementation.

Both experimental studies and fire scenario observations have revealed that changes in deformation displacement and three-dimensional deformation speed of building structure targets reflect the intrinsic characteristics of structural collapses. Consequently, deformation of the fire-affected building structure target can serve as a main indicator for assessing a building collapse risk. Acquiring real-time, accurate three-dimensional deformation amount of a key structural target in the fire-affected building is of substantial significance for providing early warning of building collapses at fire scenes and ensuring the safety of rescue personnel.

However, a traditional deformation monitoring device integrated with an Internet of things platform can provide routine monitoring and early warning for building safety risks such as settlement, inclination, cracking, and vibration, and is unsuitable for deployment in fire rescue scenarios. A laser displacement monitoring device has advantages of high precision and a long detection distance. Although being integrated with functions such as infrared temperature measurement, inclination angle sensing, and wireless transmission, the laser displacement monitoring device still adopts “single-point detection”, and is susceptible to performance degradation from intense natural light or thermal radiation, as well as interference in environments with heavy fog or dense smoke. A ground-based interferometric radar has inherent advantages such as non-contact operation, wide-area coverage, and high accuracy, and has been proven effective for measuring deformation displacement of a structural target in an actual fireground scenario in recent years. However, the ground-based interferometric radar is constrained by a monitoring angle of view, and therefore, cannot be configured to acquire deformation information of a top key point. Furthermore, rescue response time is affected due to a need of finding a temporary high point for setup. In addition, a single-radar monitoring method can be used to only acquire a displacement result along its line-of-sight direction, and cannot be used to perceive a three-dimensional spatial deformation behavior of a fire-affected building, thereby affecting effectiveness and reliability of collapse early warning.

In conclusion, the existing technology cannot meet the demand for real-time, and accurate monitoring of a three-dimensional deformation amount in a key structural target of the fire-affected building during a rescue operation. Therefore, a novel monitoring method and system is urgently needed to resolve the problem.

### SUMMARY

An objective of the present disclosure is to disclose a method and a system for monitoring deformation of a fire-affected building based on air-ground remote sensing networking, to meet a requirement of monitoring three-dimensional deformation of a top structural target of a building at the fireground.

Technical solutions of the present disclosure are as follows:

A method for deformation monitoring of a fire-affected building based on air-ground remote sensing networking includes the following steps:
acquiring radar images by a ground-based deformation monitoring radar A, an unmanned aerial vehicle-mounted deformation monitoring radar B, and an unmanned aerial vehicle-mounted deformation monitoring radar C;
performing geocoding on a remote sensing image acquired by each radar, mapping two-dimensional image coordinates, in a radar slant range-azimuth polar coordinate system, of a fire-affected building structure target to local three-dimensional spatial coordinates; and
iteratively resolving, based on distributed radar network monitoring, a three-dimensional deformation component and a three-dimensional deformation speed of the fire-affected building structure target, where
a deployed position of the unmanned aerial vehicle-mounted deformation monitoring radar C is determined as follows:
preliminarily determining, according to a right-handed coordinate system convention and directional vectors: L₁ and L₂, a candidate point of the unmanned aerial vehicle-mounted deformation monitoring radar C in combination with deployed positions of the ground-based deformation monitoring radar A and the unmanned aerial vehicle-mounted deformation monitoring radar B; and
adjusting a flight pose in an area proximate to the candidate point, calculating a number of conditions for a three-dimensional transformation matrix Min real time during the adjusting process, performing, according to the number of conditions, stability evaluation on the transformation matrix M, and determining the area proximate to the candidate point as a final deployed position of the unmanned aerial vehicle-mounted deformation monitoring radar C when the transformation matrix Mis invertible, where
the calculating a number of conditions for the three-dimensional transformation matrix M specifically includes:

$$cond ( M ) = ‖ M ‖ ‖ {M}^{- 1} ‖ ,$$

where
M⁻¹ is an inverse matrix of the three-dimensional transformation matrix M.

Further, the unmanned aerial vehicle-mounted deformation monitoring radar B is disposed at a position parallel to a vertical direction of the fire-affected building structure target.

Further, a calculation formula of the three-dimensional deformation speed is as follows:

$$\{ \begin{matrix}{V}_{{n}_{1}}^{x} = ( {x}_{{n}_{1}} - {x}_{{n}_{0}} ) / t \\ {V}_{{n}_{1}}^{y} = ( {y}_{{n}_{1}} - {y}_{{n}_{0}} ) / t \\ {V}_{{n}_{1}}^{z} = ( {z}_{{n}_{1}} - {z}_{{n}_{0}} ) / t\end{matrix} , where$$

$${V}_{{n}_{1}}^{x} , {V}_{{n}_{1}}^{y} , and {V}_{{n}_{1}}^{z}$$

are three-dimensional deformation speeds of the fire-affected building structure target, xₙ_{₁}, yₙ_{₁}, and zₙ_{₁} are positions of the deformed building structure target, xₙ_{₀}, yₙ_{₀}, and zₙ_{₀} are initial positions of the fire-affected building structure target, and t is a radar monitoring and sampling period.

The present disclosure further provides a system for monitoring deformation of a fire-affected building based on air-ground remote sensing networking, including a ground-based deformation monitoring radar A, an unmanned aerial vehicle-mounted deformation monitoring radar B, and an unmanned aerial vehicle-mounted deformation monitoring radar C, where the ground-based deformation monitoring radar A includes a displacement monitoring module, an auxiliary functional module, an infrared thermal imaging module, an intelligent control platform, and a power supply module; and the unmanned aerial vehicle-mounted deformation monitoring radar B and the unmanned aerial vehicle-mounted deformation monitoring radar C each include a displacement monitoring module, an auxiliary functional module, and a power supply module.

Further, the displacement monitoring module includes an all-solid-state radio frequency transceiver sub-module, a high-speed data collection and processing sub-module, and a microcontroller unit (MCU) control sub-module; the all-solid-state radio frequency transceiver sub-module is configured to: transmit and receive frequency-modulated continuous wave radio frequency signals; the high-speed data collection and processing sub-module is configured to perform analog-to-digital sampling of a target echo complex signal; and the MCU control sub-module is configured to: receive a control instruction and receive information from each module;
the auxiliary functional module includes a video and image capturing sub-module, a pose monitoring sub-module, and a wireless transmission sub-module, where the pose monitoring sub-module is configured to perform positioning through a BeiDou navigation satellite system; the wireless transmission sub-module is configured to send monitored data to the intelligent control platform; and the pose monitoring sub-module is configured to record unmanned aerial vehicle pose information.
the intelligent control platform is configured to: send a clock synchronization signal, receive monitored data of the radar displacement monitoring module, and the auxiliary functional module, and perform, based on radar pose data, iterative optimization on a three-dimensional transformation matrix, to complete three-dimensional deformation decomposition of a fire-affected building structure target; and
the infrared thermal imaging module is configured to monitor a temperature distribution status of the fire-affected building in real time, and show a temperature difference of different parts of the fire-affected building by using a thermal imaging technology.

Further, the power supply module is configured to provide electric power supply to each module of the ground-based deformation monitoring radar A, the unmanned aerial vehicle-mounted deformation monitoring radar B, and the unmanned aerial vehicle-mounted deformation monitoring radar C.

Compared with the conventional technology, the present disclosure has the following advantages.

First, all-around and multi-angle monitoring of the fire-affected building is achieved through a networking manner integrating the ground-based deformation monitoring radar A, and the unmanned aerial vehicle-mounted deformation monitoring radars B and C, so that not only stability of the ground-based radar is utilized, but also maneuverability and flexibility of an unmanned aerial vehicle-mounted radar are achieved. Therefore, single-point detection limit of a conventional monitoring device is overcome. Then, a three-dimensional deformation processing method in the system can be used to accurately resolve, according to measured data of the radar, a three-dimensional deformation component and a three-dimensional deformation speed under a local spatial coordinate system by using a precise formula and an iterative algorithm, to provide quantifiable and accurate data for evaluating a deformation state of a building structure. Then, a sight-of-line direction of the unmanned aerial vehicle-mounted deformation monitoring radar B is controlled to be approximately parallel to a Z-axis of a spatial coordinate system, thereby ensuring precise acquisition of deformation information in a vertical direction of the fire-affected building structure target. For the deployed position of the unmanned aerial vehicle-mounted deformation monitoring radar C, the candidate point is preliminarily determined according to a unique determining manner, namely, the right-handed coordinate system convention and directional vectors L₁ and L₂ in combination with deployed positions of the ground-based deformation monitoring radars, flight pose adjustment is performed in a proximate area, and stability of the three-dimensional transformation matrix M is evaluated according to a number of conditions of the three-dimensional transformation matrix M, to ensure that the matrix is invertible, and therefore, scientific basis and reliability of a monitoring point are ensured, and accuracy of a monitored result is improved.

### BRIEF DESCRIPTION OF THE DRAWINGS

The accompanying drawings illustrate various embodiments by way of example rather than limitation, and together with the specification and claims, serve to explain the embodiments of the present disclosure. Where appropriate, same reference numerals are used in all drawings to designate identical or corresponding features. Such embodiments are exemplary and are not intended to be exhaustive or exclusive embodiments of the apparatus or method.

FIG. 1 is a schematic diagram of monitoring based on air-ground remote sensing networking according to the present disclosure;

FIG. 2 is a schematic diagram of a monitoring system according to the present disclosure; and

FIG. 3 is a schematic diagram of a three-dimensional deformation processing procedure according to the present disclosure.

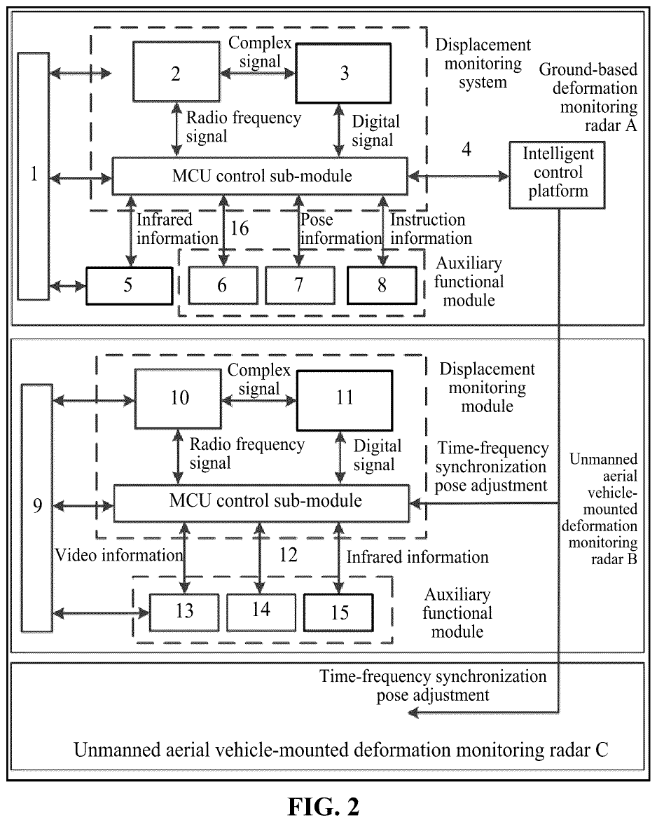

Reference numerals in FIG. 2: 1, Power supply module; 2, All-solid-state radio frequency transceiver sub-module; 3, High-speed data collection and processing sub-module; 4, Time-frequency synchronization control signal; 5, Infrared thermal imaging; 6, Video and image capturing; 7, Pose monitoring; 8, Wireless transmission; 9, Power supply module; 10, All-solid-state radio frequency transceiver sub-module; 11, High-speed data collection and processing sub-module; 12, Pose information; 13, Video and image capturing; 14, Pose capturing; 15, Wireless transmission; 16, Video information.

### BRIEF DESCRIPTION OF THE EMBODIMENTS

It should be noted that the embodiments in the present disclosure and features in the embodiments may be combined with each other in a non-conflicting situation. The present disclosure will be described in detail below with reference to the drawings and embodiments.

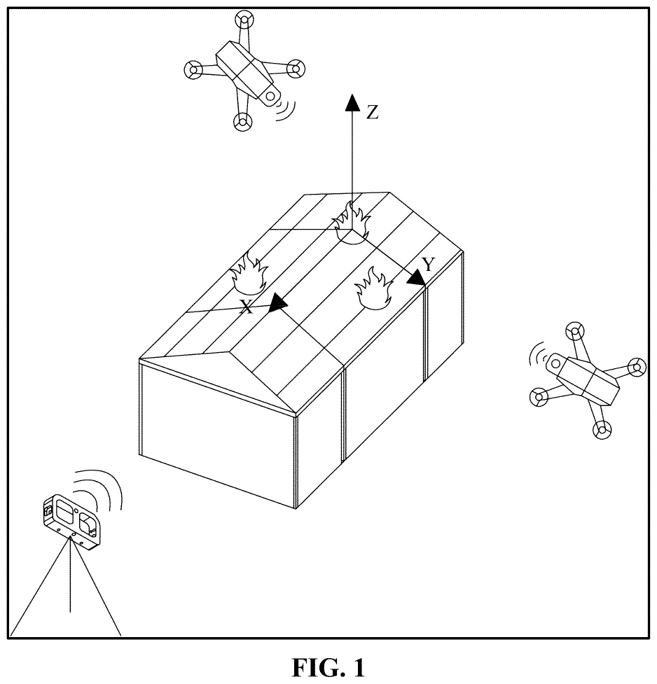

As shown in FIG. 1 and FIG. 2, an embodiment of the present disclosure provides a system for monitoring deformation of a fire-affected building based on air-ground remote sensing networking, including a ground-based deformation monitoring radar A, an unmanned aerial vehicle-mounted deformation monitoring radar B, and an unmanned aerial vehicle-mounted deformation monitoring radar C. The ground-based deformation monitoring radar A includes a displacement monitoring module, an auxiliary functional module, an infrared thermal imaging module, an intelligent control platform, and a power supply module. The unmanned aerial vehicle-mounted deformation monitoring radar B and the unmanned aerial vehicle-mounted deformation monitoring radar C each include a displacement monitoring module, an auxiliary functional module, and a power supply module.

The displacement monitoring module includes an all-solid-state radio frequency transceiver sub-module, a high-speed data collection and processing sub-module, and a microcontroller unit (MCU) control sub-module. The all-solid-state radio frequency transceiver sub-module is configured to: transmit and receive frequency-modulated continuous wave radio frequency signals. The high-speed data collection and processing sub-module is configured to perform analog-to-digital sampling of a target echo complex signal. The MCU control sub-module is configured to: receive a control instruction and receive information from each module.

The auxiliary functional module includes a video and image capturing sub-module, a pose monitoring sub-module, and a wireless transmission sub-module. The pose monitoring sub-module is configured to perform positioning through a BeiDou navigation satellite system. The wireless transmission sub-module is configured to send monitored data to the intelligent control platform. The pose monitoring sub-module is configured to record unmanned aerial vehicle pose information.

The intelligent control platform is configured to: send a clock synchronization signal, receive monitored data of the radar displacement monitoring module and the auxiliary functional module, and perform, based on radar pose data, iterative optimization on a three-dimensional transformation matrix, to complete three-dimensional deformation decomposition of a fire-affected building structure target.

The infrared thermal imaging module is configured to monitor a temperature distribution status of the fire-affected building in real time, and show a temperature difference of different parts of the fire-affected building by using a thermal imaging technology.

The power supply module is configured to provide electric power supply to each module of the ground-based deformation monitoring radar A, the unmanned aerial vehicle-mounted deformation monitoring radar B, and the unmanned aerial vehicle-mounted deformation monitoring radar C.

According to another aspect, the present disclosure further provides a method for processing deformation of a fire-affected building based on air-ground remote sensing networking, including the following steps.

In a first step, equivalent phase center coordinates of the ground-based deformation monitoring radar A, the unmanned aerial vehicle-mounted deformation monitoring radar B, and the unmanned aerial vehicle-mounted deformation monitoring radar C are set as r_{A}, r_{B}, and r_{C}, where each coordinate value is a measured result of a total station measurement (or a measured result of a three-dimensional laser scanning device), and is represented as follows:

$$\{ \begin{matrix}{r}_{A} = ( {x}_{a} , {y}_{a} , {z}_{a} ) \\ {r}_{B} = ( {x}_{b} , {y}_{b} , {z}_{b} ) \\ {r}_{C} = ( {x}_{c} , {y}_{c} , {z}_{c} )\end{matrix} . \qquad ( 1 )$$

An initial coordinate vector of a target point of a Nₜₕ building key structure is set to p_{N}_{₀} and a coordinate value thereof is a measured result of the total station instrument or a measured result of the three-dimensional scanning device, and is represented as follows:

$${p}_{{N}_{0}} = ( {x}_{{n}_{0}} , {y}_{{n}_{0}} , {z}_{{n}_{0}} ) . \qquad ( 2 )$$

In a second step, with measurements values of three deformation monitoring radars being respectively d_{A}, d_{B}, and d_{C}, p_{N}_{₁}=(xₙ_{₁},yₙ_{₁},zₙ_{₁}) is resolved, which satisfies the following equation set:

$$\{ \begin{matrix}{d}_{A} = ‖ {r}_{A} - {p}_{{N}_{1}} ‖ - ‖ {r}_{A} - {p}_{{N}_{0}} ‖ \\ {d}_{B} = ‖ {r}_{B} - {p}_{{N}_{1}} ‖ - ‖ {r}_{B} - {p}_{{N}_{0}} ‖ \\ {d}_{C} = ‖ {r}_{C} - {p}_{{N}_{1}} ‖ - ‖ {r}_{C} - {p}_{{N}_{0}} ‖\end{matrix} . \qquad ( 3 )$$

If a function of three variables f(·) with respect to xₙ_{₁}, yₙ_{₁}, and zₙ_{₁} can be represented as follows:

$$f ( {p}_{{N}_{1}} ) = {f}_{A} ( {x}_{{n}_{1}} , {y}_{{n}_{1}} , {z}_{{n}_{1}} ) = \sqrt{{( {x}_{{n}_{1}} - {x}_{a} )}^{2} + {( {y}_{{n}_{1}} - {y}_{a} )}^{2} + {( {z}_{{n}_{1}} - {z}_{a} )}^{2}} \qquad ( 4 )$$

Then,

$$f ( {p}_{{N}_{0}} ) = {f}_{A} ( {x}_{{n}_{0}} , {y}_{{n}_{0}} , {z}_{{n}_{1}} ) = \sqrt{{( {x}_{{n}_{0}} - {x}_{a} )}^{2} + {( {y}_{{n}_{0}} - {y}_{a} )}^{2} + {( {z}_{{n}_{0}} - {z}_{a} )}^{2}} . \qquad ( 5 )$$

In a third step, if a displacement of the target between two consecutive measurements is small, that is, ∥p_{N}_{₁}−p_{N}_{₀}∥ is a small variable, then Taylor expansion can be performed on the function of three variables at p_{N}_{₀} to keep a linear term while a higher-order infinitesimal is neglected. In addition, three constants C_{A}, C_{B}, and C_{C} are respectively set to:

$$\{ \begin{matrix}‖ {r}_{A} - {p}_{{N}_{0}} ‖ = {C}_{A} \\ ‖ {r}_{B} - {p}_{{N}_{0}} ‖ = {C}_{B} \\ ‖ {r}_{C} - {p}_{{N}_{0}} ‖ = {C}_{C}\end{matrix} . \qquad ( 6 )$$

Then, a to-be-resolved equation set is represented by using a matrix as follows:

$$[ \begin{matrix}{d}_{A} \\ {d}_{B} \\ {d}_{C}\end{matrix} ] = [ \begin{matrix}\frac{{x}_{{n}_{0}} - {x}_{a}}{{C}_{A}} & \frac{{y}_{{n}_{0}} - {y}_{a}}{{C}_{A}} & \frac{{z}_{{n}_{0}} - {z}_{a}}{{C}_{A}} \\ \frac{{x}_{{n}_{0}} - {x}_{b}}{{C}_{B}} & \frac{{y}_{{n}_{0}} - {y}_{b}}{{C}_{B}} & \frac{{z}_{{n}_{0}} - {z}_{b}}{{C}_{B}} \\ \frac{{x}_{{n}_{0}} - {x}_{c}}{{C}_{C}} & \frac{{y}_{{n}_{0}} - {y}_{c}}{{C}_{C}} & \frac{{z}_{{n}_{0}} - {z}_{c}}{{C}_{C}}\end{matrix} ] \cdot [ \begin{matrix}{x}_{{n}_{1}} - {x}_{{n}_{0}} \\ {y}_{{n}_{1}} - {y}_{{n}_{0}} \\ {z}_{{n}_{1}} - {z}_{{n}_{0}}\end{matrix} ] . \qquad ( 7 )$$

In a fourth step, if d=(d_{A},d_{B},d_{C})^{T}, and a matrix of first-order Taylor expansion values at p_{N}_{₀} is M, then

$$M = [ \begin{matrix}\frac{{x}_{{n}_{0}} - {x}_{a}}{{C}_{A}} & \frac{{y}_{{n}_{0}} - {y}_{a}}{{C}_{A}} & \frac{{z}_{{n}_{0}} - {z}_{a}}{{C}_{A}} \\ \frac{{x}_{{n}_{0}} - {x}_{b}}{{C}_{B}} & \frac{{y}_{{n}_{0}} - {y}_{b}}{{C}_{B}} & \frac{{z}_{{n}_{0}} - {z}_{b}}{{C}_{B}} \\ \frac{{x}_{{n}_{0}} - {x}_{c}}{{C}_{C}} & \frac{{y}_{{n}_{0}} - {y}_{c}}{{C}_{C}} & \frac{{z}_{{n}_{0}} - {z}_{c}}{{C}_{C}}\end{matrix} ] . \qquad ( 8 )$$

By using coordinates of three radars, coordinates of a target point, and three displacement measure values, a novel position p_{N}_{₁} of a moved target can be obtained as follows:

$${p}_{{N}_{1}} = {M}^{- 1} \cdot d + {p}_{{N}_{0}} . \qquad ( 9 )$$

Herein, p_{N}_{₀} is an initial coordinate vector of the target point of the building key structure, d is a measurement value of a monitoring radar, and Mis a three-dimensional transformation matrix.

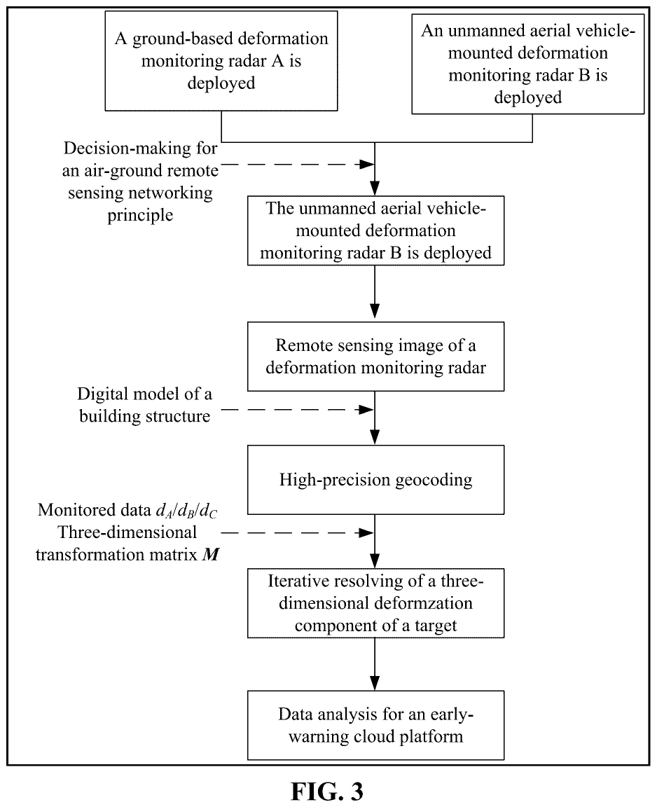

As shown in FIG. 3, the present disclosure provides a method for monitoring deformation of a fire-affected building based on air-ground remote sensing networking, including the following steps.

In a first step, a ground-based deformation monitoring radar A is deployed after the fire and rescue service arrives at a building fire scene.

In a second step, after an unmanned aerial vehicle-mounted deformation monitoring radar B is flown to a position over a fire-affected building structure target, a line-of-sight monitoring direction of the unmanned aerial vehicle-mounted deformation monitoring radar B is approximately parallel to a Z-axis of a spatial coordinate system.

In a third step, an unmanned aerial vehicle-mounted deformation monitoring radar C is flown to a monitoring point through scheduling according to an air-ground remote sensing networking principle, and a description of the principle is as follows.

The monitoring point of the unmanned aerial vehicle-mounted deformation monitoring radar C is preliminarily determined according to a right-handed coordinate system convention and directional vectors: L₁ and L₂. However, being limited by an actual fireground monitoring condition, the unmanned aerial vehicle-mounted deformation monitoring radar C may have difficulty in covering a critical structural target on the top of the building.

To obtain a three-dimensional deformation component of the fire-affected building structure target through decomposition, an obtained indispensable constraint is that the three-dimensional transformation matrix M should be invertible. A number of conditions cond(M)=∥M∥∥M⁻¹∥ of the invertible matrix Mis used to describe sensitivity of a linear system to error disturbance, so as to assess stability of the linear system. If the number of conditions of the matrix is large, a fierce change is caused to a resolution of the linear system even a variable of the linear system has a slight change.

Pose adjustment is performed in an area proximate to a preliminarily selected point, and the transformation matrix M is evaluated according to the number of conditions to finally determine a monitoring point of the unmanned aerial vehicle-mounted deformation monitoring radar C.

In a fourth step, high-precision geocoding is performed on a remote sensing image acquired by a deformation monitoring radar, and two-dimensional image coordinates, in a radar slant range-azimuth polar coordinate system, of the fire-affected building structure target are mapped to local three-dimensional spatial coordinates.

In a fifth step, the three-dimensional deformation component, in a local coordinate system, of the fire-affected building structure target is obtained through iterative resolving according to a spatial relative position, and a three-dimensional deformation speed

$$( {V}_{{n}_{1}}^{x} , {V}_{{n}_{1}}^{y} , {V}_{{n}_{1}}^{z} )$$

is calculated as follows:

$$\{ \begin{matrix}{V}_{{n}_{1}}^{x} = ( {x}_{{n}_{1}} - {x}_{{n}_{0}} ) / t \\ {V}_{{n}_{1}}^{y} = ( {y}_{{n}_{1}} - {y}_{{n}_{0}} ) / t \\ {V}_{{n}_{1}}^{z} = ( {z}_{{n}_{1}} - {z}_{{n}_{0}} ) / t\end{matrix} . \qquad ( 10 )$$

Herein,

$${V}_{{n}_{1}}^{x} , {V}_{{n}_{1}}^{y} , and {V}_{{n}_{1}}^{z}$$

are three-dimensional deformation speeds of the fire-affected building structure target, xₙ_{₁}, yₙ_{₁}, and zₙ_{₁} are positions of the deformed building structure target, xₙ_{₀}, yₙ_{₀}, and zₙ_{₀} are initial positions of the fire-affected building structure target, and t is a radar monitoring and sampling period.

Finally, a result is uploaded to a monitoring and early-warning cloud platform in real time.

The above are merely preferred specific embodiments of the present disclosure, but the protection scope of the present disclosure is not limited thereto. Any equivalent replacement or modification made by a person skilled in the art according to the technical solutions of the present disclosure and inventive concepts thereof within the technical scope of the present disclosure shall fall within the protection scope of the present disclosure.

What is claimed is:

1. A method for monitoring deformation of a fire-affected building based on air-ground remote sensing networking, comprising the following steps:
acquiring radar images by a ground-based deformation monitoring radar A, an unmanned aerial vehicle-mounted deformation monitoring radar B, and an unmanned aerial vehicle-mounted deformation monitoring radar C;
performing geocoding on a remote sensing image acquired by each radar, and mapping two-dimensional image coordinates, in a radar slant range-azimuth polar coordinate system, of a fire-affected building structure target to local three-dimensional spatial coordinates; and
iteratively resolving, based on distributed radar network monitoring, a three-dimensional deformation component and a three-dimensional deformation speed of the fire-affected building structure target, wherein
a deployed position of the unmanned aerial vehicle-mounted deformation monitoring radar C is determined as follows:
preliminarily determining, according to a right-handed coordinate system convention and directional vectors: L₁ and L₂, a candidate point of the unmanned aerial vehicle-mounted deformation monitoring radar C in combination with deployed positions of the ground-based deformation monitoring radar A and the unmanned aerial vehicle-mounted deformation monitoring radar B; and
adjusting a flight pose in an area proximate to the candidate point, calculating a number of conditions for a three-dimensional transformation matrix Min real time during the adjusting process, performing, according to the number of conditions, stability evaluation on the transformation matrix M, and determining the area proximate to the candidate point as a final deployed position of the unmanned aerial vehicle-mounted deformation monitoring radar C when the transformation matrix Mis invertible, wherein
the calculating a number of conditions for three-dimensional transformation matrix M specifically comprises:
$$cond ( M ) = ‖ M ‖ ‖ {M}^{- 1} ‖ ,$$
M⁻¹ is an inverse matrix of the three-dimensional transformation matrix M;
$$M = [ \begin{matrix}\frac{{x}_{{n}_{0}} - {x}_{a}}{{C}_{A}} & \frac{{y}_{{n}_{0}} - {y}_{a}}{{C}_{A}} & \frac{{z}_{{n}_{0}} - {z}_{a}}{{C}_{A}} \\ \frac{{x}_{{n}_{0}} - {x}_{b}}{{C}_{B}} & \frac{{y}_{{n}_{0}} - {y}_{b}}{{C}_{B}} & \frac{{z}_{{n}_{0}} - {z}_{b}}{{C}_{B}} \\ \frac{{x}_{{n}_{0}} - {x}_{c}}{{C}_{C}} & \frac{{y}_{{n}_{0}} - {y}_{c}}{{C}_{C}} & \frac{{z}_{{n}_{0}} - {z}_{c}}{{C}_{C}}\end{matrix} ] ,$$
wherein, xₐ, yₐ, and zₐ are equivalent phase center coordinates of the ground-based deformation monitoring radar A, x_{b}, y_{b}, and z_{b} are equivalent phase center coordinates of the unmanned aerial vehicle-mounted deformation monitoring radar B, x_{c}, y_{c}, and z_{c} are equivalent phase center coordinates of the unmanned aerial vehicle-mounted deformation monitoring radar C, xₙ₀, yₙ₀, and zₙ₀ is an initial coordinate vector of a target point of a N^{th} building key structure; C_{A}, C_{B}, and C_{C} are constants;
the unmanned aerial vehicle-mounted deformation monitoring radar B is disposed at a position parallel to a vertical direction of the fire-affected building structure target; and
a calculation formula of the three-dimensional deformation speed is as follows:
$$\{ \begin{matrix}{V}_{{n}_{1}}^{x} = ( {x}_{{n}_{1}} - {x}_{{n}_{0}} ) / t \\ {V}_{{n}_{1}}^{y} = ( {y}_{{n}_{1}} - {y}_{{n}_{0}} ) / t \\ {V}_{{n}_{1}}^{z} = ( {z}_{{n}_{1}} - {z}_{{n}_{0}} ) / t\end{matrix} ,$$
wherein
$${V}_{{n}_{1}}^{x} , {V}_{{n}_{1}}^{y} . and {V}_{{n}_{1}}^{z}$$
are three-dimensional deformation speeds of the fire-affected building structure target, xₙ_{₁}, yₙ_{₁}, and zₙ_{₁} are positions of a deformed building structure target, xₙ_{₀}, yₙ_{₀}, and zₙ_{₀} are initial positions of the fire-affected building structure target, and t is a radar monitoring and sampling period.

2. A system for monitoring deformation of a fire-affected building based on air-ground remote sensing networking, applying the method for monitoring deformation of a fire-affected building based on air-ground remote sensing networking according to claim 1, and comprising: a ground-based deformation monitoring radar A, an unmanned aerial vehicle-mounted deformation monitoring radar B, and an unmanned aerial vehicle-mounted deformation monitoring radar C, wherein the ground-based deformation monitoring radar A comprises a displacement monitoring module, an auxiliary functional module, an infrared thermal imaging module, an intelligent control platform, and a power supply module; and the unmanned aerial vehicle-mounted deformation monitoring radar B and the unmanned aerial vehicle-mounted deformation monitoring radar C each comprise a displacement monitoring module, an auxiliary functional module, and a power supply module.

3. The system for monitoring deformation of a fire-affected building based on air-ground remote sensing networking according to claim 2, wherein the displacement monitoring module comprises an all-solid-state radio frequency transceiver sub-module, a high-speed data collection and processing sub-module, and a microcontroller unit (MCU) control sub-module; the all-solid-state radio frequency transceiver sub-module is configured to: transmit and receive frequency-modulated continuous wave radio frequency signals; the high-speed data collection and processing sub-module is configured to perform analog-to-digital sampling of a target echo complex signal; and the MCU control sub-module is configured to: receive a control instruction and receive information from each module;
the auxiliary functional module comprises a video and image capturing sub-module, a pose monitoring sub-module, and a wireless transmission sub-module, wherein the pose monitoring sub-module is configured to perform positioning through a BeiDou navigation satellite system; the wireless transmission sub-module is configured to send monitored data to the intelligent control platform; and the pose monitoring sub-module is configured to:
the intelligent control platform is configured to: send a clock synchronization signal, receive monitored data of the radar displacement monitoring module, and the auxiliary functional module, and perform, based on radar pose data, iterative optimization on a three-dimensional transformation matrix, to complete three-dimensional deformation decomposition of a fire-affected building structure target; and
the infrared thermal imaging module is configured to monitor a temperature distribution status of the fire-affected building in real time, and show a temperature difference of different parts of the fire-affected building by using a thermal imaging technology.

4. The system for monitoring deformation of a fire-affected building based on air-ground remote sensing networking according to claim 2, wherein the power supply module is configured to provide electric power supply to the ground-based deformation monitoring radar A, the unmanned aerial vehicle-mounted deformation monitoring radar B, and the unmanned aerial vehicle-mounted deformation monitoring radar C.
